(19) United States
(12) Patent Application Publication
(10) Pub. No.: US 2025/0162291 A1
(43) Pub. Date: May 22, 2025

(54) METHOD OF MANUFACTURING A STABILIZED VENEER AND STABILIZED VENEER

(71) Applicant: Flooring Technologies Ltd., KALKARA (MT)

(72) Inventors: Bernd Stiewe, Nieheim (DE); Joachim Hasch, Berlin (DE); Norbert Kalwa, Horn - Bad Meinberg (DE)

(73) Assignee: Flooring Technologies Ltd., KALKARA (MT)

(21) Appl. No.: 18/837,003

(22) PCT Filed: Jan. 31, 2023
(86) PCT No.: PCT/EP2023/052336

§ 371 Date: Aug. 8, 2024

(30) Foreign Application Priority Data
Feb. 9, 2022 (EP) 22155972.7

(51) Int. Cl. B32B 21/14; B32B 5/02; B32B 7/12; B32B 21/06; B32B 21/10; B32B 37/10; B32B 37/14

(52) U.S. Cl. CPC B32B 21/14; B32B 5/022; B32B 7/12; B32B 21/06; B32B 21/10; B32B 37/1027; B32B 37/14; B32B 2250/02; B32B 2255/02

(57) ABSTRACT

The invention relates to a method for manufacturing a stabilized veneer without a carrier board, a stabilized veneer and a veneered board. In order to provide a method for manufacturing a veneer as well as a veneer, wherein the veneer is particularly stable and in particular has a particularly high mechanical stability against compressive loads, can be easily and safely processed as an intermediate product, has a particularly low veneer thickness and is thus particularly inexpensive to manufacture and still has a good real wood look and real wood haptic, it is provided that the method for manufacturing a stabilized and/or a rollable veneer without a carrier board has as method steps first a provision of a stabilization sheet, followed by a coating on one side, in particular a top side, of the stabilization sheet with a condensation resin, and subsequently a pressing of the stabilization sheet and the veneer layer to configure a stabilization layer by means of the condensation resin, wherein the condensation resin is at least partially pressed from the stabilization sheet into the veneer layer during pressing and leads there to a solidification or mechanical stabilization of the veneer.

### BACKGROUND OF THE INVENTION

The invention relates to a method for manufacturing a stabilized veneer without a carrier board, a stabilized veneer without a carrier board and a veneered board.

When manufacturing products for a wide range of interior design, furniture and flooring applications, real wood surfaces are considered the highest quality option. However, the use of solid wood supplies high product costs and complex production. In addition, the availability of the corresponding quantity of wood and wood in the required format is often limited.

Veneers have long been used to provide customers with products with a real wood surface. However, the problem with veneers is that they tend to break during processing if they are less than one millimeter thick and are correspondingly difficult to process, which usually leads to material losses and the associated additional costs. Another problem is that such veneers are also very sensitive to mechanical damage due to their low thickness.

These problems become all the more serious the larger the veneers are. This also has to do with the fact that large-format veneers are composed of smaller veneer sections. These veneer sections are typically bonded together at the narrow faces before use and partially stabilized by a glue thread on the backside of the veneer sheet.

A known prior art solution to improve the workability of a large-format veneer sheet is to bond a stabilization layer to the backside, as described for example in EP 1 911 580 A1. However, this still does not improve the resistance of the veneer to punctual compressive stresses during processing or later use, as the adhesive does not penetrate the veneer layer. In principle, there is also still the problem that thin, large-format veneer sheets are difficult to manipulate without causing damage. Such damage, for example during production and processing, can only be avoided with expensive technical solutions and even then there is still a high reject rate, which significantly increases production costs and ultimately the product price.

Another prior art solution for improving stability and, in particular, resistance to mechanical stresses is to apply a thick varnish layer to the veneer surface. However, customers demand surfaces with a wood appearance that is as unaltered as possible, so that the veneer can at best be surface-treated with small amounts of lacquer or oil. This provides protection against soiling and fading, but not against pressure stresses. However, this is a major problem, particularly for flooring and other surfaces subject to high mechanical loads, which can currently in the state of the art only be solved by working with higher veneer thicknesses.

### SUMMARY AND DISCLOSURE OF THE INVENTION

The invention is therefore based on the technical object of providing a method for manufacturing a veneer as well as a veneer, whereby the veneer is particularly stable without a carrier board and in particular has a particularly high mechanical stability against compressive loads, can be easily and safely processed as an intermediate product, has a particularly low veneer thickness and is therefore particularly inexpensive to manufacture and still has a good real wood look and real wood haptic.

According to the invention, the object is solved by a method for manufacturing a stabilized veneer and a veneered board all as disclosed herein. Advantageous further embodiments of the invention are also disclosed herein and/or given in the dependent claims.

The method according to the invention for manufacturing a stabilized and/or a rollable veneer without a carrier board and/or as an independent product has as method steps first a provision of a stabilization sheet, followed by a coating on one side, in particular a top side, of the stabilization sheet with a condensation resin, and subsequently a pressing of the stabilization sheet and the veneer layer to configure a stabilization layer by means of the condensation resin, wherein the condensation resin is at least partially pressed from the stabilization sheet into the veneer layer during pressing and results there in a solidification or mechanical stabilization of the veneer.

Furthermore, the invention relates to a stabilized veneer without a carrier board and/or as an independent product, in particular manufactured according to the method of the invention, which has a stabilization sheet pressed onto a backside of the veneer layer and a stabilization layer extending continuously from the stabilization sheet into the backside of the veneer layer and consisting of a condensation resin pressed into the veneer layer from the stabilization sheet.

Finally, the invention relates to a veneered board having a carrier board and a stabilized veneer according to the invention arranged above the carrier board.

The inventors have recognized that by introducing a condensation resin into the backside of the veneer layer by means of a stabilization sheet, a mechanical stabilization of the veneer can be achieved, in particular also against compressive stresses, and in addition, by using a stabilization sheet in combination with the targeted introduction of the condensation resin, a stabilization layer extending over the stabilization sheet into the veneer layer can be formed, which leads to a significant improvement in the mechanical properties as well as the processability of the insulated veneer. This makes it possible to use a particularly thin veneer layer and thus keep the production and product costs of the stabilized veneer low. Finally, the front side and thus the wood surface of the stabilized veneer remains unchanged and natural due to the pressing of the condensation resin into the veneer layer from the backside, so that an unchanged wood surface look and wood surface haptic is achieved. In addition, the solution according to the invention increases the variability of processing, since the stabilized veneer can typically be rolled up and can be stored, used and further processed accordingly as rolled goods.

Accordingly, the stabilized veneer according to the invention is a laminated material or a composite material which is formed from at least two layers, the veneer layer and the stabilization sheet. These two layers are preferably inseparably bonded together in the finished veneer. Furthermore, the manufacture of the veneer according to the invention is carried out without a carrier board and/or as an independent product and/or independently of any subsequent fixing to any surface.

According to the invention, the stabilized veneer does not have a carrier board. The carrier board is understood to be the solid surface or a component with a solid surface that is to be modified by the application of the veneer. In particular, a stabilized veneer without a carrier board is not a veneered furniture panel, a veneered floor panel, a veneered wall panel or a veneered ceiling panel. Furthermore, the stabilized veneer preferably has only the veneer layer and a stabilization sheet as layers or material layers. In principle, however, further layers or sheets, in particular transparent layers such as a lacquer coating, can be provided on the veneer layer.

The stabilized veneer according to the invention is still a veneer for applying and finishing a material surface and not a surface of another object already provided with a veneer. Accordingly, the stabilized veneer is a stand-alone product that is manufactured individually and can be stored and handled independently of a carrier or carrier board and, in particular, does not need to be directly stabilized by a carrier board. This represents a significant advantage of the invention, as previously corresponding veneers connected to a stabilization sheet were always connected to a carrier board at the same time and thus the veneer was not available as an independent product for further applications. Thus, the stabilized veneer is formed to be arranged on and bonded to a surface in order to modify the surface.

The stabilization sheet preferably extends over the entire surface of the stabilized veneer and/or has a substantially constant thickness over the entire surface. Further preferably, the stabilization sheet has a constant composition and/or the same mechanical properties over the entire surface. It is also preferred that the stabilization sheet is bendable, rollable and/or flexible. Furthermore, it is preferred that the stabilization sheet is not formed from wood and/or a wood-based material. Particularly preferably, the stabilization sheet is provided exclusively for stabilizing the veneer and in particular preferably does not form a structure of a piece of furniture, a furniture panel, another panel material or a panel, in particular for arranging on the top, a wall and/or the floor.

The stabilization sheet is provided for coating one side with a condensation resin, whereby the stabilization sheet is preferably formed in such a way that the condensation resin applied to the surface of the stabilization sheet can at least partially penetrate into the stabilization sheet. The coating on one side can be carried out in any desired manner. It is possible to apply the condensation resin immediately before further use or to apply it and then soak the stabilization sheet. The coating can be carried out using a liquid condensation resin or by any application of a solid material.

Alternatively, however, the stabilization sheet can also be formed in such a way that little or no condensation resin can penetrate, so that the coating is preferably an exclusively superficial application of the condensation resin and, particularly preferably, the condensation resin cannot subsequently penetrate the stabilization sheet and/or soak through it. Although any appropriately liquid-resistant or liquid-impermeable stabilization sheet can be used for this purpose, the use of parchment paper is particularly preferred for this purpose. Another particularly preferred embodiment also provides for a biocomposite based on cellulose and, in particular, vulcanized fiber or Vulkament to be used as the stabilization sheet. This advantageously results in a biocomposite with a veneer layer, in particular with a real wood veneer surface.

Preferably, however, the coating is carried out as a liquid coating, in particular directly on the surface of the stabilization sheet. Furthermore, it is preferred that the backside of the stabilization sheet, i.e. the surface of the stabilization sheet facing away from the veneer layer, has no coating with condensation resin and/or no external layer formed exclusively from condensation resin during manufacture of the stabilized veneer and/or in the stabilized veneer. Accordingly, a preferred embodiment of the method according to the invention provides that a side of the stabilization sheet opposite the coated side is free of a coating with the condensation resin. Likewise, the bottom side of the stabilization sheet is preferably not provided with any synthetic resin and/or with any adhesive at least before and/or during pressing.

According to the invention, the stabilization sheet is arranged on a backside of a veneer layer and pressed therewith. The backside of a veneer layer is preferably the side of the veneer layer that is opposite the surface of the finished, stabilized veneer. Accordingly, the front side of the veneer layer is intended to form the surface of the stabilized veneer and/or to remain visible. A layer of real wood is preferably used as the veneer layer, which can initially have any thickness, whereby thicknesses between 0.5 mm and 10 mm are generally common for veneers. However, due to the stabilization with the condensation resin, significantly lower layer thicknesses are possible. The veneer can be manufactured in one piece from a log by slicing or peeling. However, it can also be composed of individual pieces that are joined together, e.g. by binders or so-called glue threads. The veneer preferably has essentially the same dimensions as the stabilization sheet.

According to the invention, the stabilization sheet and the veneer layer are joined to manufacture the stabilized veneer by pressing, whereby the pressing can in principle be carried out statically or dynamically. In any case, according to the invention, pressing results to at least part of the condensation resin in being pressed from the stabilization sheet or from the surface of the stabilization sheet into the veneer layer. This is preferably carried out by liquefying the synthetic resin in the press under the effect of increased temperature and increased pressure and subsequently curing it chemically and/or solidifying it during cooling. The pressing time is typically between 20 seconds and 60 seconds. Preferably, the veneer layer has cavities, in particular production-related cracks or gaps and/or wood-typical cavities, e.g. due to cut vessels. The condensation resin then preferably penetrates into at least some of these cavities during pressing.

According to the invention, the condensation resin penetrating into the veneer layer leads to the formation of a stabilization layer which extends through the stabilization sheet into the veneer layer and thereby both connects the stabilization sheet to the veneer layer and also forms a composite material with the material of the veneer layer, in particular a penetrating composite material, which has improved material properties compared to pure wood, for example increased elasticity or flexibility and/or increased mechanical strength and in particular increased compressive strength.

Finally, to form a veneered board, the invention provides for arranging a stabilized veneer according to the invention on a carrier board and preferably bonding it thereto or joining it by means of an adhesive or synthetic resin. In principle, any board which is flat on at least one side and which forms a firm bond with an adhesive or a synthetic resin can be used as a carrier board. Preferably, wood-based boards are used, e.g. medium-density or high-density fiberboards (MDF, HDF), particle boards, OSB (oriented strand boards), solid wood boards, plywood as well as rod or stick boards, but cement-bonded particle boards or fiberboards, including fiberboards with a high binder content, as well as bio-composite boards and water-resistant boards are also suitable. Water-resistant boards are boards, including wood-based boards, which hardly or not at all deform when exposed to water, and in particular do not or hardly swell. The carrier board has a top side, to which the veneer is preferably applied, and a bottom side.

In principle, it is conceivable that at least two surfaces and particularly preferably two opposing surfaces and particularly preferably the top side and bottom side of the board have a stabilized veneer arranged thereon. Furthermore, it is preferred that the veneered board has a counter tension backing on the bottom side and/or opposite a veneer, wherein this counter tension backing can also be formed by a veneer or a veneer layer and in particular by a stabilized veneer according to the invention. The counter tension backing is intended to compensate for the tensile forces that are caused by the shrinkage of the synthetic resin during the curing of the adhesive or the synthetic resin on the top side of the carrier board. The counter tension backing can be a paper or cardboard impregnated with synthetic resin, for example.

The condensation resin can basically be any synthetic resin and is used as a binder. The condensation resin is preferably a thermosetting resin, in particular an aminoplastic or phenol-based resin. Melamine resin, phenolic resin, urea resin or mixtures of these resins are typically used. A melamine-formaldehyde resin, a urea-formaldehyde resin and/or a phenol-formaldehyde resin or mixtures of several of these resins are particularly preferred as the condensation resin. The condensation resin is preferably used as an aqueous solution with a solids content of 50 wt. % to 60 wt. %, the solids content being particularly preferably to be equated with the content of synthetic resin or condensation resin. Also preferably, the condensation resin or the synthetic resin is used in an amount that ensures that the synthetic resin penetrates the veneer at least in sections. Also preferably, the resin application is carried out in one step or as an application of exactly one condensation resin or resin mixture.

In a preferred further development of the method according to the invention, the condensation resin is a postforming resin and/or is made flexible by means of at least one elasticizer in such a way that the stabilized veneer can be rolled up into a roll after pressing. Flexibilizing agents that can be used in this process include diols, caprolactam, guanidine derivatives and sugar. Depending on the degree of flexibilization required, they are preferably added to the condensation resins in a proportion of 2% to 15%, and particularly preferably 5% to 10%, of the mass of the condensation resin. It is possible to add the flexibilizing agent during the production of the condensation resin or subsequently to the finished condensation resin. Furthermore, preferably after pressing or after manufacture of the stabilized veneer, the finished veneer is rolled up to form a roll and/or for further processing as rolled goods.

Furthermore, it is preferred that the condensation resin has at least one additive, in particular selected from the group containing hardener, wetting agent, colorant, pigment, effect pigment, flame retardant, ink, UV stabilizer, infrared absorber, agent for increasing conductivity, antibacterial agent, hydrophobizing agent, bleaching agent and/or stain. A mixture of two or more additives is particularly preferred. At least one additive, some of the additives or all of the additives can be applied to the stabilization sheet and/or introduced into the veneer together with the condensation resin. However, it is also conceivable to apply at least one additive, some of the additives or all of the additives separately to the condensation resin, to the surface of the stabilization sheet and/or to the backside of the veneer layer, in particular before pressing.

Each additive can be applied and/or supplied to the condensation resin both as a particulate solid and in liquid form. The additive can also be in granular form. Alternatively, a liquid or pasty additive can be used. In addition, each additive may be completely soluble in the condensation resin, although it is preferred that at least one additive is not soluble in the binder or is not homogeneously soluble in the binder. In particular, it is advantageous to arrange a non-soluble additive on the surface of the coated stabilization sheet and/or between the stabilization sheet and the veneer layer so that it is carried or pressed through the veneer layer at least in sections during the pressing process, whereby the additive is distributed in the veneer in a targeted manner. On the one hand, this allows the additive to be used particularly sparingly. On the other hand, a higher concentration of the additive reaches the veneer or the veneer surface in a targeted manner, so that the effect of the respective additive is better guaranteed.

A significant advantage of the method according to the invention is that a veneer layer of particularly low material thickness can be used and then stabilized in such a way that the mechanical properties are at least comparable to those of a veneer layer of significantly greater material thickness. Accordingly, a preferred embodiment of the method according to the invention provides that the veneer layer has a thickness of less than or equal to 1 mm, preferably between 0.01 mm and 1 mm, particularly preferably between 0.1 mm and 1 mm, very particularly preferably between 0.2 mm and 0.5 mm and in particular less than 0.3 mm.

In general, veneer layers and veneers with such a low thickness are very sensitive to mechanical damage and are also very difficult to handle. In particular, it is not possible to roll such veneers or use them as rolled goods. However, a veneer layer of such low thickness only becomes sufficiently mechanically stable through the stabilization layer produced, so that use with higher demands on the mechanical properties is also possible. Finally, suitable stabilization enables the veneer produced to be rolled up despite the low material thickness and/or particularly error-free and simple further processing.

According to a particularly preferred embodiment of the method according to the invention, the pressing is carried out by means of a double belt press or by means of a CPL press, whereby on the one hand a structure of the stabilized veneer with several layers can be produced in a simple manner and on the other hand a continuous production of stabilized veneer is possible. In particular, the use of a double belt press or dynamic pressing in general makes it possible to produce the stabilized veneer in rolls and/or to roll up long sections of the manufactured veneer after it has been produced. In particular, a continuous material can be produced in this way, which can also be used in industries in which the processing of rolled goods is common. Alternatively, however, pressing can also be carried out using a static press, in particular a short-cycle and/or multi-platen press.

In order to enable the pressing of condensation resin into the veneer layer, the pressing is preferably carried out at an increased temperature and under pressure. An advantageous further development of the method according to the invention provides that the pressing is carried out at a pressure of between 10 bar and 100 bar, preferably between 10 bar and 70 bar, particularly preferably between 15 bar and 50 bar and especially preferably between 20 bar and 30 bar and/or at a temperature of between 120° C. and 250° C., preferably between 150° C. and 220° C., particularly preferably between 160° C. and 200° C. and especially preferably between 170° C. and 190° C. In particular, pressing is preferably carried out at 180° C. and at a pressure of 25 bar, optionally with a maximum deviation of 10% in each case, as on the one hand a sufficiently deep penetration of the condensation resin into the veneer layer is achieved here and on the other hand a complete penetration of the condensation resin through the veneer layer can be prevented, which would lead to an undesirable surface appearance and/or surface haptics of the stabilized veneer.

Although the stabilization sheet can be formed from any material and have any thickness, it is preferred that a parchment, a paper, a non-woven, a Vulkament or another fibrous sheet is used as the stabilization sheet and/or the grammage of the stabilization sheet is between 15 g/m² and 500 g/m², preferably between 25 g/m² and 300 g/m², particularly preferably between 50 g/m² and 250 g/m² and very particularly preferably between 50 g/m² and 150 g/m², in particular when parchment paper is used as the stabilization sheet.

In order to be able to better control the penetration of the condensation resin into the veneer layer, a condensation resin with a defined viscosity can be used. A defined water content is also very advantageous, whereby the use of a condensation resin with a water mass content of between 4% and 7% is preferred and between 5% and 6% is particularly preferred. Additionally or alternatively, however, it is also conceivable to dry the coating of the stabilization sheet with the condensation resin to a residual moisture of less than 10%, preferably less than 8%, particularly preferably less than 7.5% and most preferably less than 6% before arranging the stabilization sheet on the backside of the veneer layer, in order to obtain a predefined state before pressing and thus achieve a particularly easily repeatable or controllable penetration of the condensation resin into the veneer layer by means of the method. The residual moisture is particularly preferably at least 5%. Unless otherwise stated, all percentages refer to the mass.

Of course, it is also possible to impregnate a stabilization sheet with a resin on both sides and then apply a veneer on both sides. The symmetrical structure produces distortion-free products. These can be used with or without surface finishing, e.g. as thin decorative items that can be used on both sides. Here again, the high mechanical stability is of benefit.

In an advantageous further development of the method according to the invention, a further visual and/or tactile design of the stabilized veneer obtained can be achieved by arranging a decorative film, a high-gloss decorative film and/or a structuring agent, in particular for producing different gloss levels and/or a transfer paper for transferring prints to the veneer layer and in particular to the front side or surface of the veneer layer during pressing.

Finally, a preferred embodiment of the veneered board provides that the bonding of the stabilized veneer and the carrier board is carried out by means of an adhesive or resin other than the condensation resin used to manufacture the stabilized veneer, in particular a PU adhesive or a PU hot melt adhesive, and/or in a separate bonding and/or pressing process. In particular, the bonding of the stabilized veneer and the carrier board is preferably carried out by laminating the veneer.

### DETAILED DESCRIPTION

Several exemplary embodiments of a method for manufacturing a stabilized veneer according to the invention are described in more detail below:

### Exemplary Embodiment 1

In a first embodiment of a method for manufacturing a stabilized veneer, a parchment with a grammage of 50 g/m² is first coated on one side with a melamine resin in an impregnation channel. The application quantity is 100 g resin/m² (liquid).

The melamine resin has a solids content of 55% by weight. Furthermore, the melamine resin is a so-called postforming resin, i.e. a resin that is made particularly flexible with the aid of an elasticizer, so that the stabilized veneer can be bent and, in particular, rolled up. Conventional additives such as hardeners, wetting agents etc. are also added to the resin, but these are not essential for the basic properties for carrying out the method.

The resin applied to the parchment is then optionally dried in the impregnation channel to a residual moisture of approx. 6% by weight. At the end of the impregnation channel, the parchment is rolled up. The roll with the parchment is then clamped and unwound on a CPL press or a double belt press with the resin-coated side facing upwards. An oak veneer with a material thickness of 0.6 mm is then carefully laid onto the parchment from another roll in order to avoid damaging the veneer layer. The unwinding speed is 10 m/min. The CPL press is operated at a temperature of 180° C. and a pressure of 25 bar. Downstream the press, the pressed structure of the stabilized veneer is rolled up into a veneer roll, which can be easily handled without damaging the veneer. Alternatively, the stabilized veneer can also be cut to size as required.

In contrast to a veneer sheet without a stabilizing by a backside coating, this can also be manipulated in particularly large dimensions, for example 5600×2070 mm, without damage.

In order to test the mechanical stability and, in particular, the pressure resistance of the stabilized veneer, the veneer with the backside coating is then laminated onto an 8 mm thick HDF on a laminating press. The adhesive used is a PU hotmelt with an adhesive quantity of 100 g/m². For comparison purposes, an oak veneer without backside coating was also laminated onto an HDF. A ball drop test (DIN EN 13329:2016-08, large ball) was then carried out on both boards. A drop height of 750 mm was determined for the board with the veneer without backside coating. In contrast, a significantly higher value of 1600 mm was achieved for the board with the stabilized veneer with the backside coating, which impressively documents the mechanical stabilization of the veneer.

### Exemplary Embodiment 2

In a second embodiment of a method for manufacturing a stabilized veneer, an overlay with a grammage of 25 g/m² is impregnated with a melamine resin in an impregnation channel. The application quantity is 180 g/m² (liquid) and the solids content is 55% by weight.

The melamine resin is again a postforming resin, i.e. a resin that is made particularly flexible with the help of an elasticizer so that the stabilized veneer can be bent and, in particular, rolled up. Conventional auxiliary substances such as hardeners, wetting agents etc. are also added to the resin, but these are not essential for the basic properties for carrying out the method.

The overlay is dried in the impregnation channel to a residual moisture of approx. 6% by weight. At the end of the channel, the overlay is rolled up. The roll with the overlay is then clamped again on a CPL press and unwound. An oak veneer with a material thickness of 0.6 mm is then placed on the overlay from another roll. This time, a release paper is run along the bottom side of the overlay. The unwinding speed is 10 m/min. The CPL press is operated at a temperature of 180° C. and a pressure of 25 bar.

By varying the pressing parameters, the rising of the melamine resin could be controlled by means of temperature and pressure in such a way that the best possible impregnation of the veneer is achieved without the resin becoming visible on the top side of the veneer. Downstream the press, the pressed structure of the stabilized veneer is either rolled up or cut to size.

Once again, a ball drop test was carried out, which showed a significant improvement in the mechanical properties of the stabilized veneer.

### Exemplary Embodiment 3

In a third embodiment of the method according to the invention, a glass fleece with a grammage of 30 g/m² is first impregnated with a mixture of urea and melamine resin in an impregnation channel to manufacture a particularly thin stabilized veneer. The application quantity is 60 g/m² (liquid) with a solids content of 55% by weight.

The melamine resin is again a postforming resin that was made particularly flexible with the help of an elasticizer. The glass fleece is then dried in the impregnation channel to a residual moisture of around 6% by weight. At the end of the channel, the impregnated nonwoven is rolled up.

The roll with the fleece is then clamped to a CPL press and unwound. An oak veneer with a material thickness of 0.3 mm is then placed on the fleece from another roll. A release paper runs along the bottom side of the fleece. The unwinding speed is again 10 m/min. The CPL press is operated at a temperature of 180° C. and a pressure of 25 bar. By varying the pressing parameters, it was possible to control the rise of the melamine resin in such a way that the veneer was impregnated as well as possible without the resin being visible on the top side of the veneer. Downstream the press, the pressed structure of the stabilized veneer is either rolled up or cut to size. Here too, an improvement in the mechanical properties was demonstrated by means of a ball drop test.

### Exemplary Embodiment 4

A fourth embodiment of the method according to the invention for manufacturing a particularly thin stabilized veneer differs from the preceding embodiment only in that a stabilization sheet of vulcanized fiber called Vulkament is used to obtain a biocomposite with a surface of a real wood veneer, in particular an oak veneer. In this case too, a ball drop test shows a significant improvement in the mechanical properties.

1. Method for manufacturing a stabilized veneer without a carrier board, comprising the steps of:
providing a stabilization sheet,
one-sided coating of the stabilization sheet with a condensation resin,
arranging the stabilization sheet with the coating on the backside of a veneer layer,
pressing the stabilization sheet and the veneer layer to form a stabilization layer, whereby
the condensation resin is at least partially pressed out of the stabilization sheet into the veneer layer during pressing, where it supplies mechanical stabilization to the veneer.

2. Method according to claim 1, wherein one side of the stabilization sheet opposite the coated side is free of a coating with the condensation resin.

3. Method according to claim 1, wherein a melamine-formaldehyde resin, a urea-formaldehyde resin and/or a phenol-formaldehyde resin or mixtures of several of these resins are used as the condensation resin.

4. Method according to claim 1, wherein the condensation resin is a postforming resin and/or is adjusted to be flexible by means of at least one elasticizer in such a way that the stabilized veneer can be rolled up into a roll after pressing.

5. Method according to claim 1, wherein the condensation resin comprises at least one additive selected from the group consisting of hardener, wetting agent, colorant, pigment, effect pigment, flame retardant, ink, UV stabilizer, infrared absorber, agent for increasing conductivity, antibacterial agent, hydrophobizing agent, bleaching agent, stain and combinations thereof.

6. Method according to claim 1, wherein the veneer layer has a thickness of between 0.1 mm and 1 mm.

7. Method according to claim 1, wherein the pressing is carried out by means of a double belt press.

8. Method according to claim 1, wherein the pressing is carried out at a pressure of between 10 bar and 70 bar and/or at a temperature of between 150°° C. and 220° C.

9. Method according to claim 1, wherein a parchment, a paper, a nonwoven, a vulcanized fiber or another fibrous layer is used as the stabilization sheet and/or the grammage of the stabilization sheet is between 50 g/m² and 300 g/m².

10. Method according to claim 1, wherein vulcanized fiber is used as stabilization sheet in order to obtain a biocomposite.

11. Method according to claim 1, wherein the coating of the stabilization sheet with the condensation resin is dried to a residual moisture of less than 7.5% before the stabilization sheet is arranged on the backside of the veneer layer.

12. Method according to claim 1, wherein a structuring agent and/or a transfer paper for transferring prints to the veneer are arranged on the surface of the veneer layer during pressing.

13. Stabilized veneer without a carrier board, comprising
a stabilization sheet pressed onto the backside of the veneer layer and
a stabilization layer extending continuously from the stabilization sheet into the backside of the veneer layer and consisting of a condensation resin pressed into the veneer sheet from the stabilization sheet.

14. Veneered board, having a carrier board and a stabilized veneer according to claim 13 arranged above the carrier board.

15. Veneered board according to claim 14, wherein the bonding of the stabilized veneer and the carrier board is carried out by means of an adhesive that differs from the condensation resin used to manufacture the stabilized veneer and/or in a separate bonding and/or pressing process.

16. Method according to claim 12, wherein the structuring agent is a structuring agent for producing different gloss levels.
